(19) United States
(12) Patent Application Publication
(10) Pub. No.: US 2018/0303041 A1
(43) Pub. Date: Oct. 25, 2018

(54) PLANTER INSERT

(71) Applicant: Matthew P. Braasch, Northfield, IL (US)

(72) Inventor: Matthew P. Braasch, Northfield, IL (US)

(21) Appl. No.: 15/493,486

(22) Filed: Apr. 21, 2017

(51) Int. Cl. A01G 9/12; A01G 9/02; A01G 9/10

(52) U.S. Cl. CPC A01G 9/12; A01G 9/10; A01G 9/02

(57) ABSTRACT

A planter insert for supporting a plant includes a base and a suspension assembly. The suspension assembly includes a plurality of attachment devices and a plurality of connectors. The suspension assembly is configured such that when assembled, each connector of the plurality of connectors is coupled to the base and is further coupled to an edge of a planter via an attachment device of the plurality of attachment devices, such that the base is removably supported by the planter.

### BACKGROUND

The present disclosure relates to a planter insert, specifically a planter insert to suspend or support plants within a planter.

Planters or planting pots come in a variety of different sizes for housing a variety of different plants. Generally, a newly purchased plant is placed in an existing pot for display. If the existing pot is bigger than the purchased plant, however, additional support is needed in order to properly place the plant within the planter. Typically, another material, which may be soil or rocks but could include artificial components such as packing peanuts, foam, etc., is added to the bottom of the pot to fill the space and support the plant. But adding additional material can be time consuming, expensive, or undesirable for other reasons.

### SUMMARY

In one embodiment, a planter insert for supporting a plant includes a base and a suspension assembly. The suspension assembly includes a plurality of attachment devices and a plurality of connectors. The suspension assembly is configured such that when assembled, each connector of the plurality of connectors is coupled to the base and is further coupled to an edge of a planter via an attachment device of the plurality of attachment devices, such that the base is removably supported by the planter.

In one embodiment, a planter insert for supporting a plant includes a base having a first side and a second side and a plurality of support members. Each support member has a first end configured for coupling to or supporting the base and a second end configured for contact with a surface of a planter. Upon assembly, the plurality of support members is positioned between the base and the planter.

In one embodiment, a planter insert for supporting a plant within a planter includes a base having a first side and an opposing a second side and a support assembly. The support assembly is configured to secure the base within the planter so that the base does not directly contact an inside surface of the planter.

Other aspects of the disclosure will become apparent by consideration of the detailed description and accompanying drawings.

### BRIEF DESCRIPTION OF THE DRAWINGS

FIG. 1 is a perspective view of a planter insert.

FIG. 2 is an exploded view of the planter insert of FIG. 1.

FIG. 3 is a perspective view of the planter insert of FIG. 1 assembled with a planter.

FIG. 4 is a top view of the planter insert of FIG. 3.

FIG. 5 is a side view of the planter insert of FIG. 3.

FIG. 6 is a perspective view of another embodiment of a planter insert with a planter.

FIG. 7 is a perspective view of another embodiment of a planter insert with a planter.

FIG. 8 is a perspective view of another embodiment of a planter insert with a planter.

FIG. 9 is a perspective view of another embodiment of a planter insert with a planter.

FIG. 10 is a perspective view of another embodiment of a planter insert.

FIG. 11 is a perspective view of another embodiment of a planter insert with a planter.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

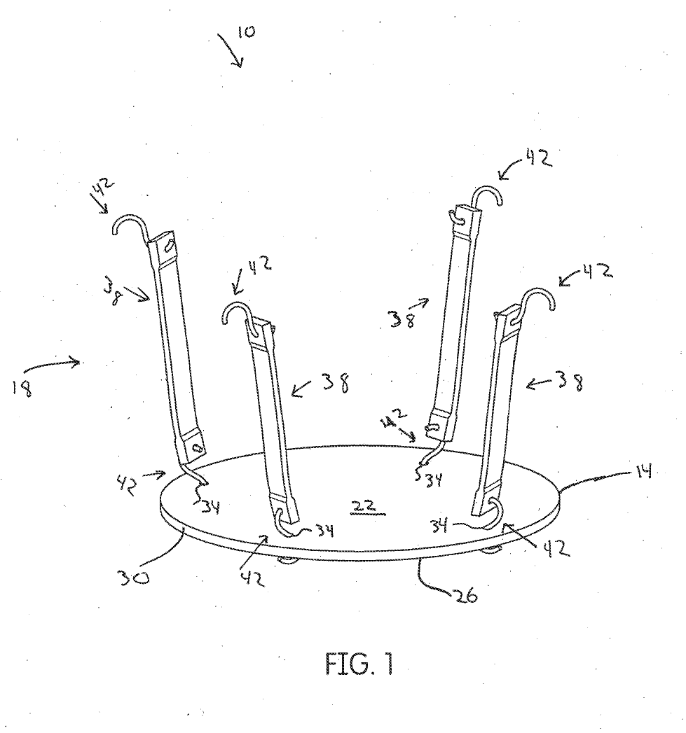

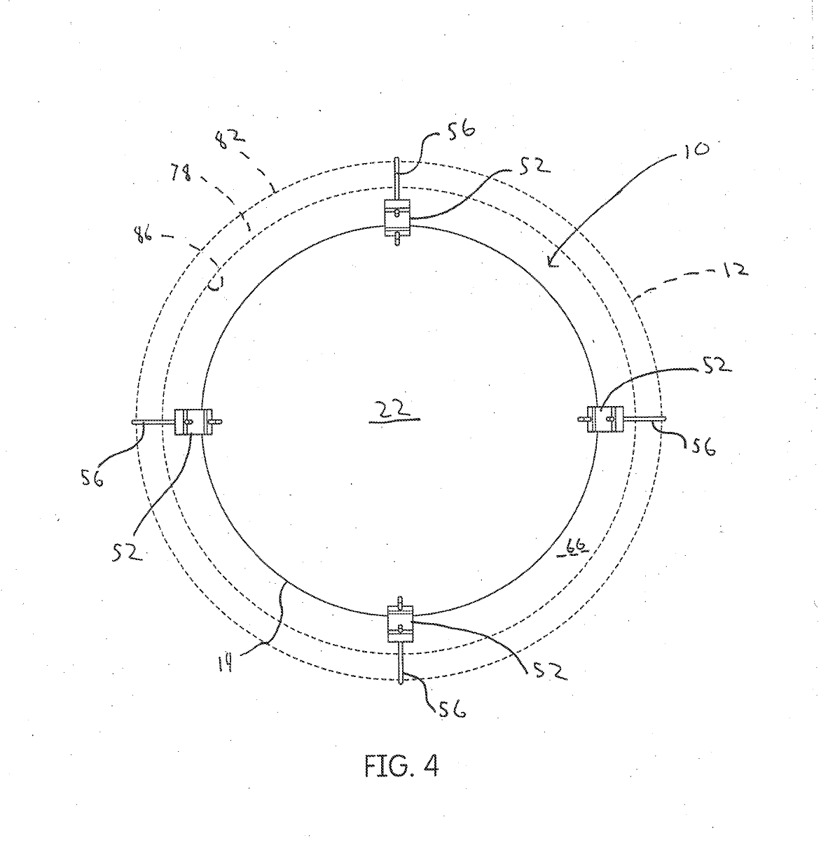

With reference to FIGS. 1-5, a planter insert 10 is shown for suspending or supporting a plant or plants inside a planter or planting pot. The planter insert 10 includes a base 14 and a support assembly or suspension assembly 18.

With continued reference to FIGS. 1-5, the base 14 of the planter insert 10 is a generally rigid uniform body made of plastic, wood, metal, or other such material, and includes a support surface or first side 22, a second side 26 opposite the first side 22, and an edge 30 therebetween. The edge 30 defines the thickness of the base 14, which may range from 0.2 in to 3.0 in.

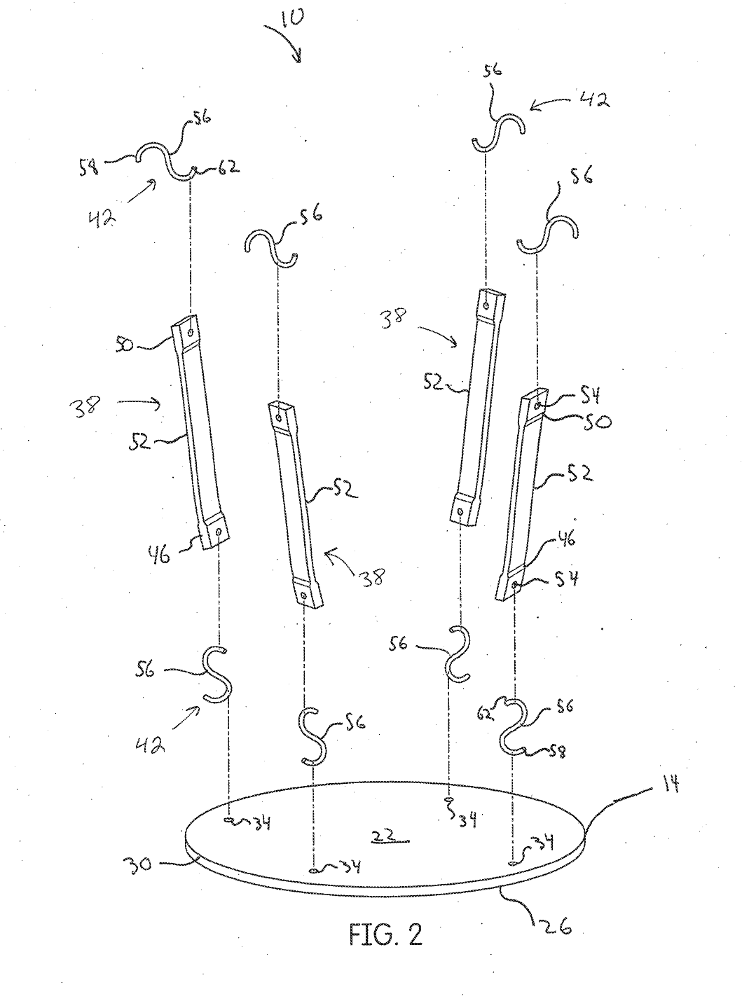

Referring in particular to FIG. 2, a plurality of apertures 34 each extend from the first side 22 of the base 14 through to the second side 26 of the base 14. The apertures 34 are equally spaced from one another circumferentially around the base 14 as well as radially from the edge 30 of the base 14. In other embodiments, the apertures 34 need not be evenly or equally spaced. In the illustrated embodiment, there are four apertures 34 but in other embodiments there may be two, three, or five or more apertures 34. Additionally, the apertures 34 can be in the form of channels, slots, grooves, etc., or of different shapes and sizes.

In the illustrated embodiment, the base 14 is circular having a diameter ranging from 4.0 inches to 12 inches or more. In some embodiments, the base is adjustable to increase or decrease the diameter discretely or continuously within the above-referenced range. In even further embodiments, the base 14 need not be circular but could be otherwise elliptical, polygonal, or of any shape or size for supporting a plant.

The suspension assembly 18 includes a plurality of support members or suspension members or connectors 38 and a corresponding plurality of attachment devices 42.

Each connector 38 has a first end 46 and a second end 50 opposite the first end 46. The connectors 38, which as illustrated in FIG. 1 may be in the form of a cord 52, strap, or similar member, may have a variety of different lengths and flexibilities dependent on the size of the planter, and may be accordingly constructed of an elastomer or other suitable polymer. In some embodiments, each connector 38 is adjustable, allowing a user to vary its length independent of its ability to stretch or flex.

With continued reference to FIGS. 1-5, the connectors 38 further include apertures 54 in the form of holes, slot, channels, or grooves, at one or both ends 46, 50 for coupling to the attachment devices 42. In the illustrated embodiment, the attachment devices 42 are in the form of hooks or s-clips 56 having a first end 58 and a second end 62. The first and second ends 58, 62 of each hook 56 may be configured similarly, but at least one of the ends 58, 62 of some of the hooks 56 are configured for coupling to an aperture 54 of a respective connector 38, with the other end 58, 62 configured for coupling to the base 14 via the apertures 34. Likewise, at least one of the ends 58, 62 of others of the hooks 56 are configured for coupling to an aperture 54 of a connector 38, with the other end configured for coupling to a planter top, lip, or edge.

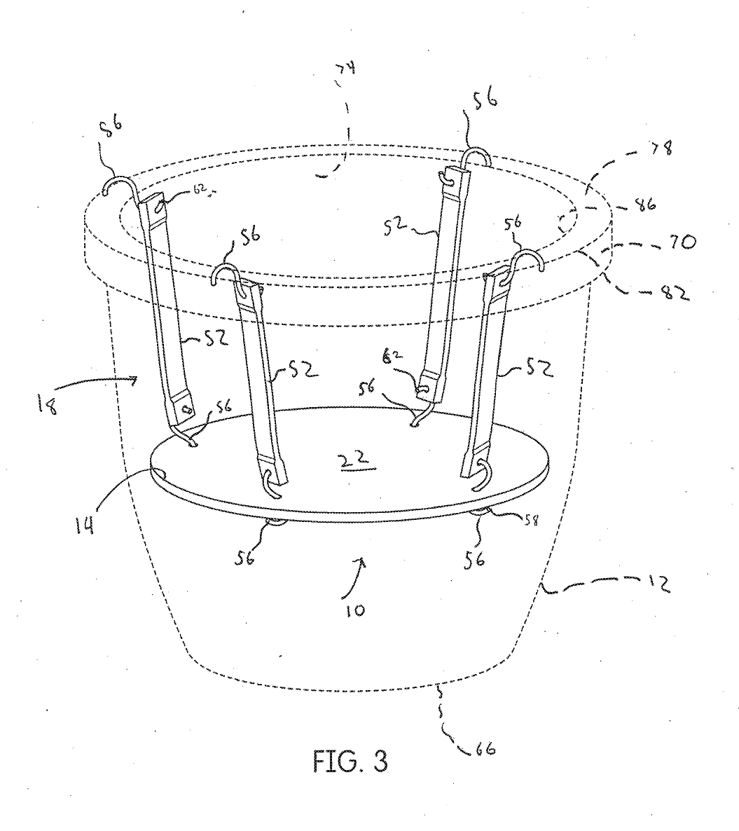

Referring also to FIG. 3, in assembly of the planter insert 10, the hooks 56 are used to couple the base 14 to the planter 12. After coupling a hook 56 to each end 46, 50 of each connector 38, the free end of one hook 56 is coupled to the base 14 via a base aperture 34 and the free end of the other hook 56 is coupled to the top or edge of the planter 12. With at least three connectors so assembled, the planter insert 10 is secured to and within the planter 12. In the illustrated embodiment, eight hooks 56 corresponding to four connectors 38 support the base 14 in the planter 12. In other embodiments, a different number of connectors 38 and attachment devices 42 are used to support or suspend the planter 12 consistent with the form and shape of the base 14. With the second ends 62 of the hooks 56 now secured to the planter 12 a user may place a plant on the base 14 to be displayed.

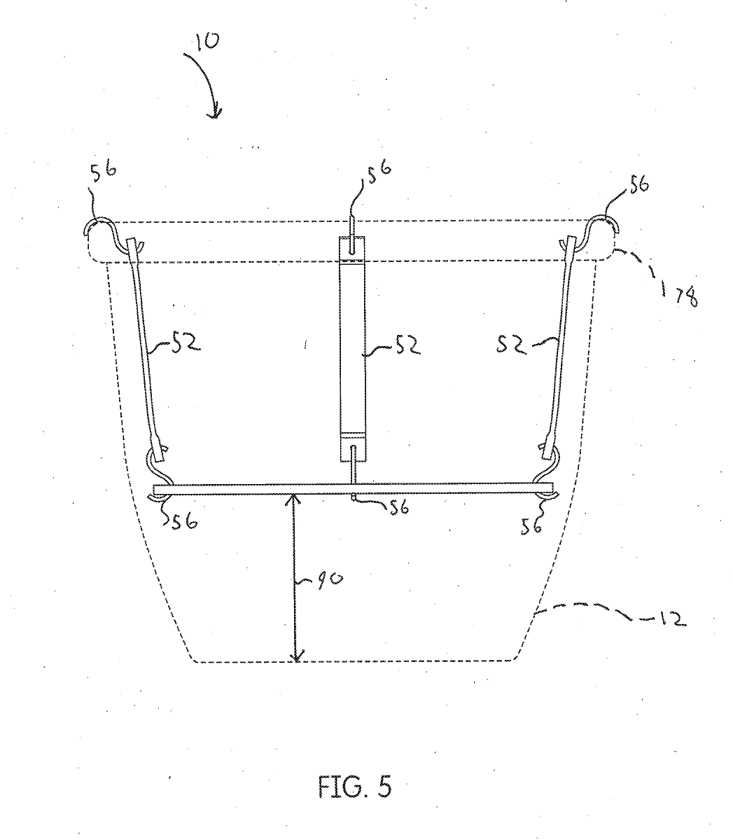

As seen in FIGS. 3-5, the planter insert 10 is seated inside the planter 12 to support a plant (not shown). The planter 12 has a bottom surface 66, an outside surface 70, an inside surface 74, and a lip 78 with a first edge 82 and second edge 86. With reference to FIG. 5, the base 14 of the planter insert 10 is suspended a distance 90 above the bottom surface 66 of the planter 12. Depending on the size of the plant, a user may adjust the length of the connectors 38, or use connectors 38 of different lengths or properties, to change the distance 90 the base 14 is suspended from the bottom 66 (or top) of the planter 12.

In some embodiments, the connectors 38 can be looped at any point between the first and second ends 46, 50 through an aperture 34 in the base 14, obviating the need for an attachment device 42 proximate the base 14. In other embodiments, the connectors 38 may be integrally formed as one piece with the base 14 or may be integrally formed with one or more attachment devices. In yet other embodiments, the apertures 34 may be replaced with hooks, loops, or other attachment components spaced about the body 14 as previously described for direct attachment with the connectors 38.

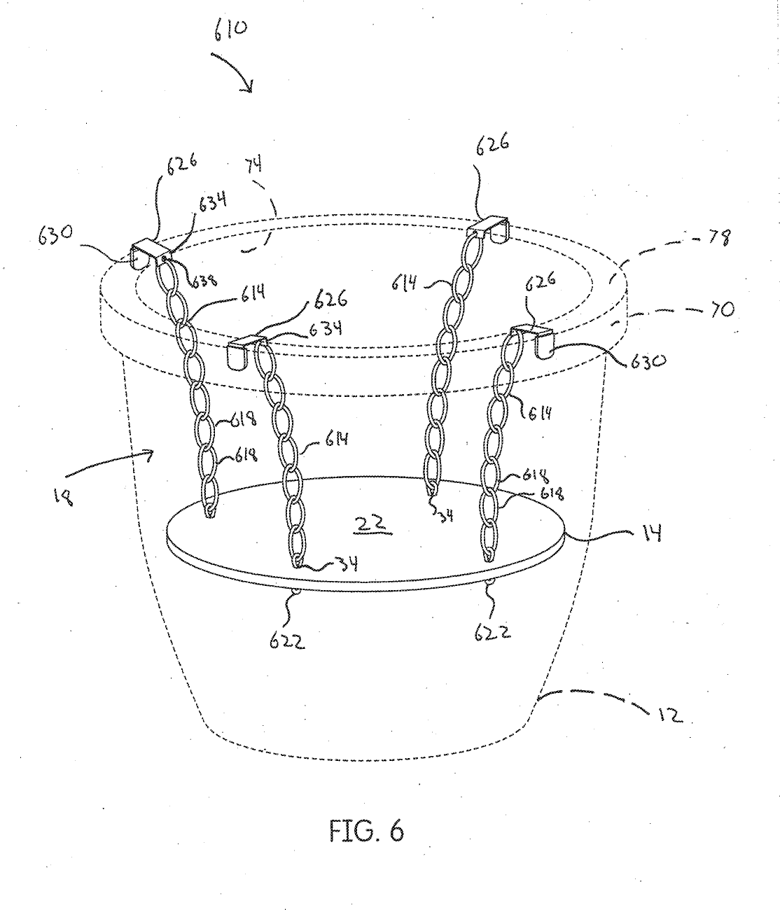

With reference to FIG. 6, a planter insert 610 is illustrated according to another embodiment. The planter insert 610 includes a similar base 14 as that of FIG. 1, but rather than cords 52, the connectors 38 of the suspension assembly 18 are in the form of chains 614 used to connect the base 14 within the planter 12. The chains 614 are formed of links 618 that can be added or removed to alter the length of each chain 614 and are less flexible than the cords 52 described with respect to the embodiment of FIG. 1. A hook 56 may be used at the base 14, but alternatively a knot 622 may be formed on the chain 614 beneath the base 14 to keep each chain 614 from sliding through the apertures 34, or the chains 614 can be instead looped for securement to the base 14 as previously described.

Although a hook 56 can also be used at the planter lip 78, as illustrated in FIGS. 1-5, a spring loaded clip 626 may be used as an attachment device 42 instead to couple the connector 38 (chain 614 in FIG. 6) to the lip 78 of the planter 12. The spring loaded clip 626 includes a first tab 630 and a second tab 634 with a slot, groove, or channel 638 for coupling to the associated chain 614. The first tab 630 extends over the lip 78 of the planter 12 and contacts the outside surface 70 and the second tab 634 contacts the inside surface 74. A spring (not shown) positioned between the first and second tab 630, 634 of the clip 626 biases the second tab 634 towards the first tab 630 to secure the clip 626 on the lip 78 of the planter 12. The biasing effect of the spring between the tabs 630, 634 allows for the clip 626 to be secured on different planters of varying lip thicknesses.

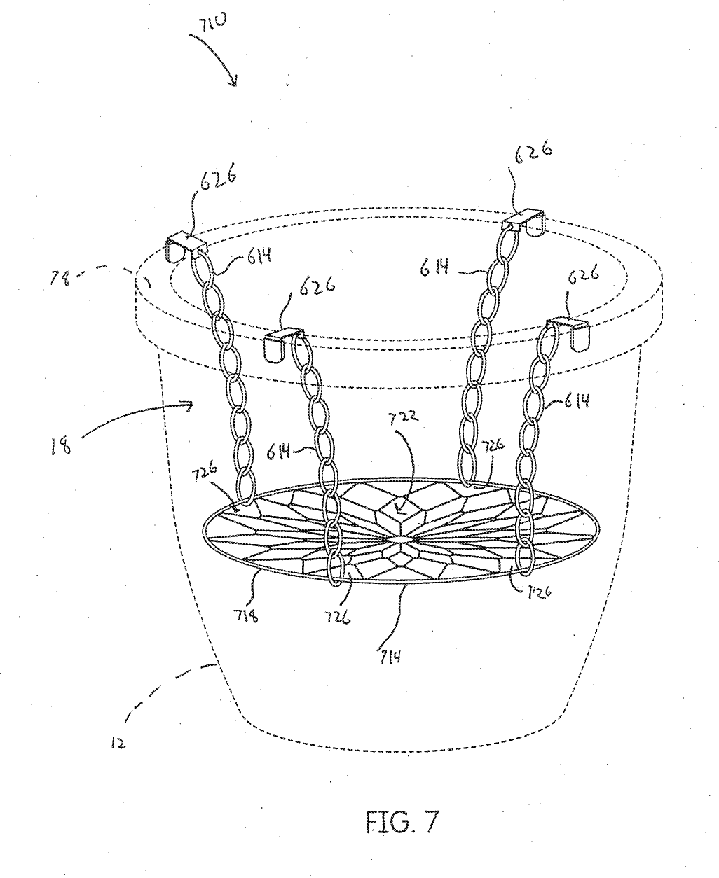

With reference to FIG. 7, a planter insert 710 is illustrated according to another embodiment. The planter insert 710 includes a similar suspension assembly 18 as the planter insert 610 of FIG. 6, but as an alternative to the previously described base 14, a flexible base 714 supports the plant within the planter 12.

The flexible base 714 has an outer ring 718 surrounding and supporting a web, mesh, lattice, net, or other patterned feature 722 inside the ring. Both the ring 718 and the web 722 are flexible and can expand to support a plant. As the ring 718 and web 722 define a plurality of openings 726, each chain 614 may be connected or looped therethrough for securement to the flexible base 714 but will preferably be coupled to the ring 718. In some embodiments, a single chain length may extend from the flexible base 714 to the clip 626, as illustrated, but in other embodiments both ends of each chain 614 are coupled to a respective clip 626, with the chain length passing around the outer ring 718 to support the flexible base 714.

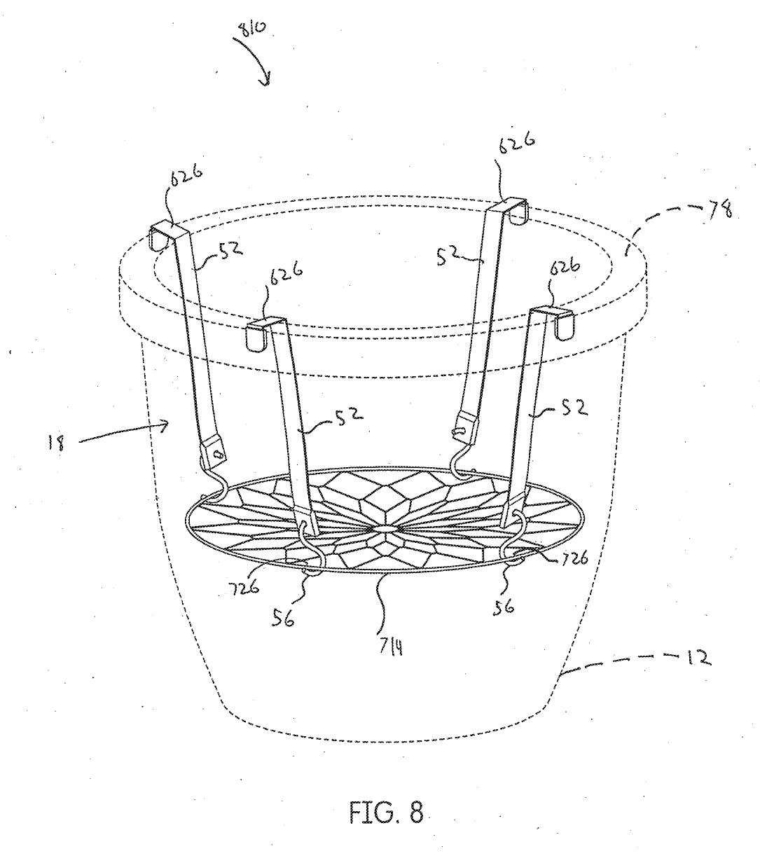

With reference to FIG. 8, a planter insert 810 is illustrated according to another embodiment. The planter insert 810 is a combination of components discussed previously. The planter insert 810 includes the flexible base 714 of FIG. 7, but rather than a chain 614 as a connector 38, a cord 52 similar to that of FIG. 1 is used but with a spring-loaded clip 626 integrally formed as one piece with each cord 52. A hook 56 or other attachment device 42, as previously described couples the cord 52 with the flexible base 714.

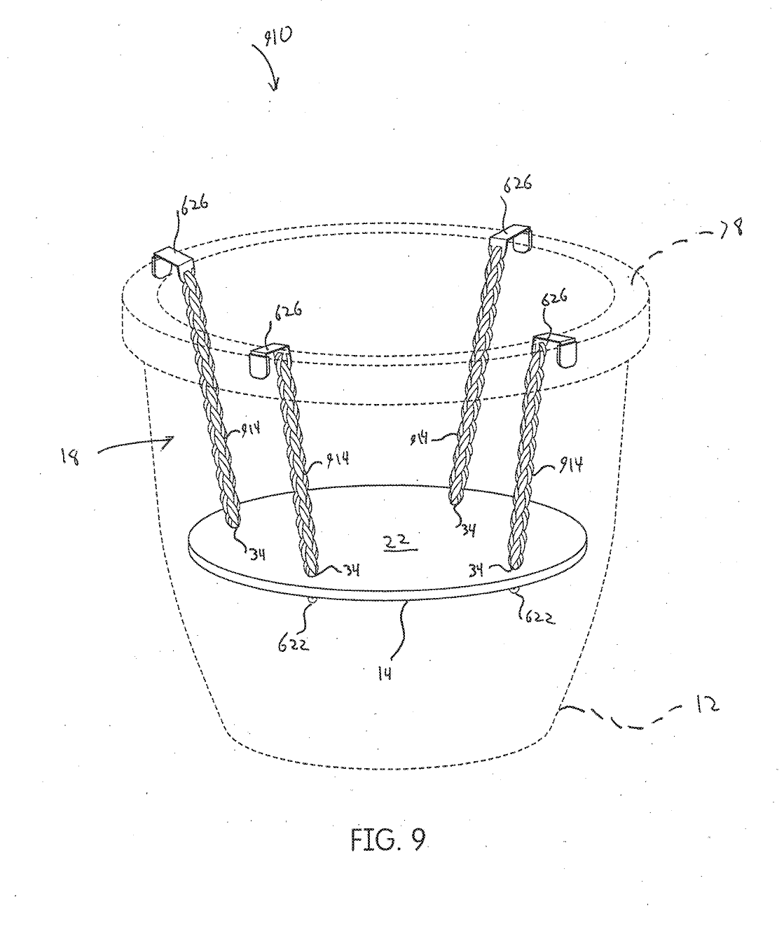

With reference to FIG. 9, a planter insert 910 is illustrated according to another embodiment of the disclosure. The planter insert 910 is similar to that of FIG. 6, but a braided cable, string, or rope 914 is used in the suspension assembly 18 in place of a chain 614. One end of the rope can be knotted or tied through the associated aperture 34 of the base 14, looped through the aperture 34, or secured with an attachment device 42 such as a hook 56. The other end of the rope 914 can be integrally formed with a clip 626 to secure the suspension assembly 18 to the lip 78 of the planter 12. In the illustrated embodiment, the rope 914 is double braided. In other embodiments, the rope 914 can be single braided, diamond braided, hollow, twisted, or plaited.

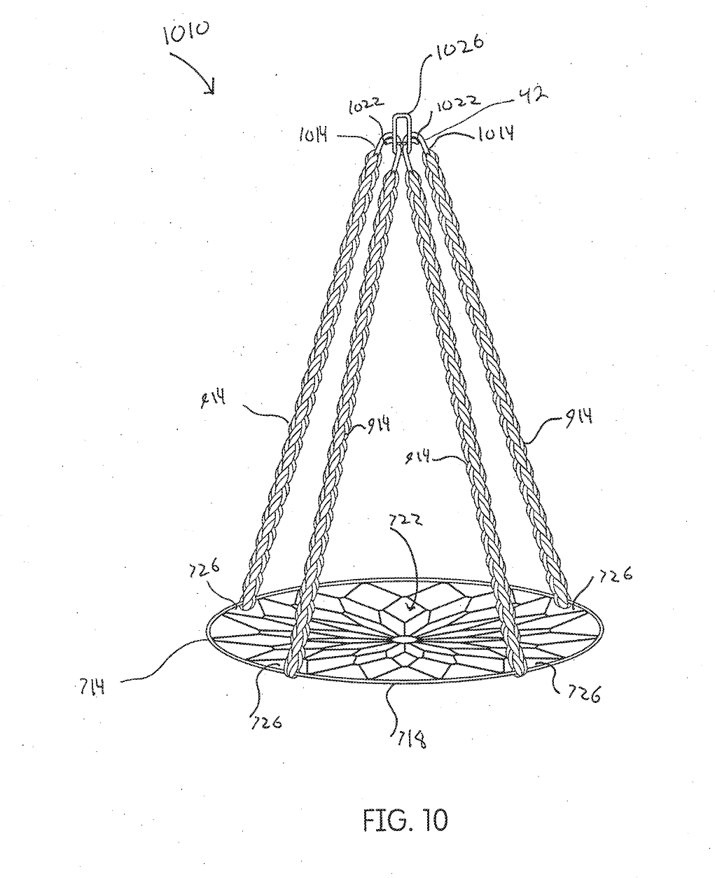

With reference to FIG. 10, a planter insert 1010 is illustrated according to another embodiment. The planter insert 1010 is configured to be supported in the planter 12 or alternatively be hung from a ceiling mount (not shown). The planter insert 1010 includes the flexible base 714, connectors 38 in the form of ropes 914, and an attachment device 42. The rope 914 can be knotted, looped, or otherwise secured to the flexible base 714 in a manner as previously described or in another known manner. The attachment device 42 may be in the form of an s-clip 42, or as shown, a j-clip 1014. The j-clip 1014 can be connected to or integrally formed with the rope 914. The j-clips 1014 each include an end hook 1022 configured to hook onto the lip 78 of the planter 12 (not shown) and also to hook to a ring or rings 1026 of a celling mount (not shown). To hang the planter insert 1010, the braided ropes 914 are drawn inwards, and the j-clips 1014 are hooked to the ceiling mount. The flexible base 714 surrounds the plant to support it on all sides while the plant insert 1010 is suspended.

In other embodiments, a first attachment device 42 (i.e., a j-clip 1014) may itself include a coupling loop or ring 1026 on a first of the attachment devices of the suspension assembly 18 such that the remaining attachment devices 42 of the suspension assembly 18 couple thereto, with the first attachment device 42 hooking to the ceiling mount. In other embodiments, the cords 52, the ropes 914, or other connectors 38 can be coupled together in additional ways, for example such as via a snap, a hook-and-loop fastener, adhesive, or by tying the ropes 914 or cords 52 together.

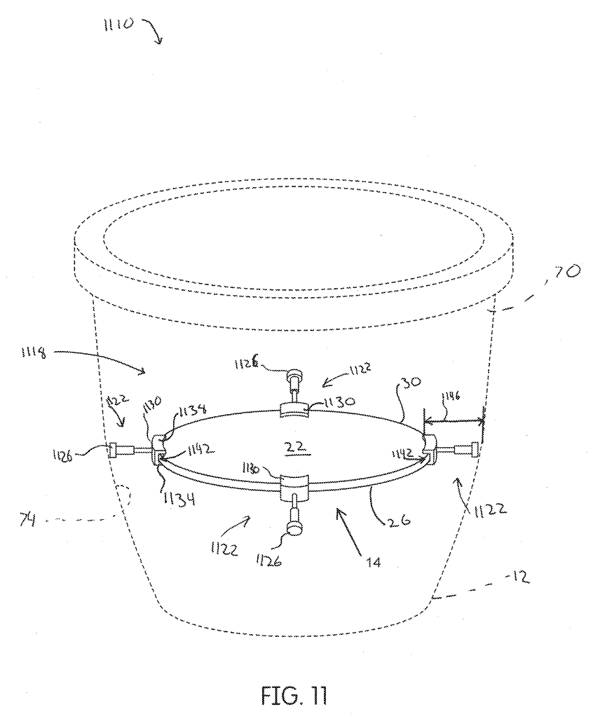

With reference to FIG. 11, a planter insert 1110 is illustrated according to another embodiment. While the planter insert 1110 includes the rigid base 14, an alternative support assembly or suspension assembly 1118 supports the planter insert 1110 inside the planter 12. The suspension assembly 1118 includes a plurality of support members or suspension members in the form of telescoping or otherwise extendable rods 1122 each having an abutment member 1126 (e.g., a cap, pad, or similar structure with an elastomer, fabric, or similar contact material) at one end and a base contact member or recessed member 1130 at the opposing end. The recessed member 1130 of the telescoping rod 1122 further includes a first arm 1134 and a second arm 1138 that define a recess 1142 therebetween. The recess 1142 may be lined with a softer or more flexible material similar to that previously described. The rod 1122 may be extended by, for example, rotating a first portion of the rod relative to a second portion of the rod.

For assembly, with three or more rods 1122 (and more particularly the recessed members 1130 of the three or more rods 1122) positioned generally equally about the base 14 such that the base 14 is supportable within the respective recesses 1142, the rods 1122 can be individually extended at a desired base height within a planter 12 through the above-described rotation of the rods 1122. Depending on the configuration of the planter 12, the abutment members 1126 may “sit” on the curved inside surface 74 as it narrows toward the bottom of the planter 12 to support the base 14 at the desired height. With other planters 12 the compression of the rods 1122 against the inside surface 74 will be sufficient to together suspend or support the base 14. The abutment member 1126 material in such instances can be tailored to provide a sufficient frictional interface with the inside surface 74. In addition, in some embodiments the arms 1134, 1138 may be adjustable relative to each other such that the base 14 is more securely held within the recesses 1142. In some embodiments, the second arm 1138 may not be present such that the base 14 rests on the first arm 1134.

The adjustment of the length of each rod (e.g., equal to a distance 1146 in a direction normal from the edge 30 of the base 14 to the inside surface 74) will be dependent on the height of the base 14 within the planter 12 and the size of the base 14, and the precise amount of extension and thus compression of the rods will be dictated by the expected loading of the base 14.

In all previously described embodiments, the assembled planter insert can be so adjusted such that no portion of the base directly contacts the inside surface of the planter.

All of the aforementioned embodiments and combinations of the planter insert are applicable to any size or shape of the following vessels, with modifications as necessary for size and shape: dwellings, flower beds, elongated flower bed pots, planters, cases, mounts, or any other vessel into which a plant may be planted and displayed.

It is to be understood that the planter insert 10, 610, 710, 810, 910, 1010 can be any combination of the components described herein and is not limited to any specific combination described herein. The flexible base 714 or the rigid base 14 can be combined with any of the support members or connectors (e.g., ropes 914, chains 614, or cords 52) and use any of the attachment members (e.g., s-clips 56, j-clips 1014, or spring loaded clips 626). In addition, the aforementioned attachment device 42 can also include other forms of fastener, such as a clasp, a tie-end, pin connection, etc., while the connectors 38 can include a variety of flexible, semi-flexible, or nonflexible materials constructed of a polymer, cloth, natural fiber, metal, wood, etc., and suitable in view of functional and aesthetic considerations.

Various features and advantages of one or more embodiments are set forth in the following claims.

What is claimed is:

1. A planter insert for supporting a plant, the planter insert comprising:
a base; and
a suspension assembly including
a plurality of attachment devices and
a plurality of connectors,
wherein the suspension assembly is configured such that when assembled, each connector of the plurality of connectors is coupled to the base and is further coupled to an edge of a planter via an attachment device of the plurality of attachment devices, such that the base is removably supported by the planter.

2. The planter insert of claim 1, wherein the base comprises a uniform body.

3. The planter insert of claim 1, wherein the base includes an outer ring.

4. The planter insert of claim 3, wherein the outer ring surrounds and supports a web

5. The planter insert of claim 3, wherein each connector of the plurality of connectors is constructed of a polymer.

6. The planter insert of claim 1, wherein the plurality of attachment devices includes a plurality of spring-biased clips.

7. The planter insert of claim 1, wherein the plurality of attachment devices is a plurality of hooks, each hook having a first end and a second end.

8. The planter insert of claim 7, wherein one of the first end or second end of each hook is configured to couple to the edge of the planter or the base and the other one of the first end or second end of each hook is configured to couple to a connector of the plurality of connectors.

9. A planter insert for supporting a plant, the planter insert comprising:
a base having a first side and a second side; and
a plurality of support members, each support member having a first end configured for coupling to or supporting the base and a second end configured for contact with a surface of a planter, wherein upon assembly, the plurality of support members is positioned between the base and the planter.

10. The planter insert of claim 9, wherein the second end of each support member is configured for removable coupling to a ceiling mount.

11. The planter insert of claim 9, wherein the base further includes an outer ring.

12. The planter insert of claim 11, wherein the outer ring surrounds and supports a web, the outer ring and web together defining a plurality of apertures, each first end configured to pass through an aperture of the plurality of apertures.

13. The planter insert of claim 9, wherein the second end of each support member is configured for coupling to an edge of the planter.

14. The planter insert of claim 9, wherein the second end of each support member is configured to abut an inside surface of the planter.

15. A planter insert for supporting a plant within a planter, the planter insert comprising:
a base having a first side and an opposing a second side; and
a support assembly,
wherein the support assembly is configured to secure the base within the planter so that the base does not directly contact an inside surface of the planter.

16. The planter insert of claim 15, wherein the support assembly includes a plurality of extendable rods.

17. The planter insert of claim 16, wherein each rod of the plurality of extendable rods includes an abutment member at a first end and a base contact member at a second end.

18. The planter insert of claim 17, wherein a portion of the base is configured to be received by the base contact member of each rod.

19. The planter insert of claim 15, wherein the support assembly includes a plurality of connectors, each connector having a first end configured for coupling to the base and a second end configured for coupling to an edge of the planter.

20. The planter insert of claim 19, wherein the base includes a plurality of apertures extending from the first side to the second side, each first end configured to pass through an aperture of the plurality of apertures.
